(19) United States
(12) Patent Application Publication
(10) Pub. No.: US 2010/0212211 A1
(43) Pub. Date: Aug. 26, 2010

(54) DEVICE FOR CATCHING INSECTS

(76) Inventors: Markus A. Scheubeck, Regensburg (DE); Thomas M. Scheubeck, Regensburg (DE)

Correspondence Address: HAYES SOLOWAY P.C., 3450 E. SUNRISE DRIVE, SUITE 140, TUCSON, AZ, 85718, US

(21) Appl. No.: 12/601,208

(22) PCT Filed: May 5, 2008
(86) PCT No.: PCT/EP08/55468

§ 371 Date: Mar. 30, 2010

(30) Foreign Application Priority Data
May 24, 2007 (DE) 10 2007 024 526.4
Mar. 28, 2008 (EP) PCT/EP2008/053730

(51) Int. Cl. A01M 1/10; A01M 1/04

(52) U.S. Cl. 43/107; 43/113

(57) ABSTRACT

The invention relates to a device (1) for catching insects, comprising an attracting plane (4) for attracting the insects to be caught, comprising an opening (6) which is arranged in the attracting plane and through which the insects can enter the device (1), wherein. the opening is adjoined by a duct (8) which extends into the interior of the device (1), and comprising a ventilation device (12) which generates an air flow passing through the duct (8). According to the invention, the duct (8) is arranged in the interior of a housing (10) and this housing (10) is provided for receiving and holding a liquid medium, wherein the ventilation device (12) is arranged in such a way that it generates an air flow in the direction of the liquid medium provided in the housing (10).

The present invention relates to a device for catching insects. Various devices for catching and/or killing insects are known from the prior art. One possibility for combating insects lies in the use of insecticides. However, such insecticides have the disadvantage that these are usually highly poisonous substances and thus there is also a potential risk to humans. Furthermore, the prior art also discloses devices which suck insects into a cavity with the aid of an air flow and keep said insects trapped therein.

DE 102 596 51 A1 discloses an insect trap. This insect trap comprises a light surface and a dark contrast point arranged within this light surface. Via this contrast point or the contrast, the insects are intended to be attracted and sucked into the interior of this insect trap. Furthermore, an attractant is also provided in the interior of this insect trap, which attractant is pushed outwards by means of a fan and serves for attracting the insects.

Convincing results can be achieved by this attractant, particularly in the case of devices in the open air. However, the use of the attractant is less suitable in closed spaces, since the attractant has an odour which is unpleasant to humans.

The object of the present invention is therefore to provide a device for catching insects which enables an efficient attraction and elimination of the insects. This is achieved by the subject matter of claim 1. Advantageous embodiments and further developments form the subject matter of the dependent claims. A device according to the invention for catching insects comprises an attracting plane for attracting the insects to be caught. Also provided in this attracting plane is an opening, through which the insects can enter the device. The opening is adjoined by a duct which extends into the interior of the device, and also provided is a ventilation device which generates an air flow passing through the duct.

According to the invention, the duct is arranged in the interior of a housing and this housing is provided for receiving and holding a liquid medium, wherein the ventilation device is arranged in such a way that it generates an air flow in the direction of the liquid medium provided in the housing.

An attracting plane is understood to mean a flat or curved surface which attracts the insects to be caught by certain optical stimuli described in detail below and causes said insects to enter the interior of the device. The ventilation device is in particular, but not exclusively, a fan which generates the aforementioned air flow through the duct and the opening. By virtue of this air flow, the insects coming into the vicinity of the duct are drawn through the duct into the interior of the housing.

Unlike the device described in DE 102 596 51 A1, in the context of the present invention a housing is provided which is closed at least in the downward direction and which at the same time serves as a holding container for a liquid medium and in particular for water. This liquid medium serves on the one hand as a catching liquid for holding the insects which enter the housing, and on the other hand this liquid medium also attracts the insects, as will be explained in detail below. In a further advantageous embodiment, the opening is provided within a passage surface through which a gaseous medium can exit from the insect trap. Specifically, with particular preference, this opening is provided essentially centrally in this passage surface. The passage surface may be designed as a netting or the like, so that a gas and optionally also a liquid can pass through the passage surface, but the insects to be caught cannot pass through said passage surface. In a further advantageous embodiment, at least two different (geometric) designs are formed on the attracting plane.

Different geometric designs are understood to mean in particular different geometric shapes, such as for example circles compared to polygons or the like. In one particularly preferred embodiment, there is provided on the attracting plane a triangle within which a circle is formed. In various tests, it has been discovered that an attracting effect for the insects can also be achieved by the different geometric shapes. In this case, it is possible for the two different geometric shapes to be formed on the attracting plane itself. Preferably, one of the two geometric shapes is formed at least partially within the other geometric shape. For example, a triangle could also be formed within a circle.

The present invention thus makes it possible to combat effectively the risk of disturbance and infection by gnats and other insects. More precisely, a reliable combating of all insects and types of gnat is achieved, and this combating takes place with little odour and noise. The corresponding device is easy to handle and maintain. Furthermore, the device according to the invention is also flexible with regard to its location of use and its type of use and is also free of poisons and insecticides.

The ventilation device of the device according to the invention for catching insects can be supplied both with voltages of 12 V and with voltages of 240 V.

The abovementioned configuration of the geometric contrast is based on the knowledge that insects and gnats not only precisely analyse the chemical composition of the attractive host scents but also have a precise idea of how the three-dimensional shape of such an air plume should look. By means of the passage surface, an easy vertical and optionally also attractant-loaded air plume is produced, which also looks similar to the upwardly directed human air plume. Attracted animals are therefore guided further into the vicinity of a suction duct by means of additional visual stimuli and are drawn into the housing or into a collecting container.

In one preferred embodiment, the exit surface is designed as a triangular surface, within which a circular opening is arranged. The optionally attractant-loaded hot air, which is similar in size to the air plume of a human, flows through this triangular surface on the upper side of the device. A high attraction for mosquitoes is achieved by the geometric contrast and the geometric shape in the centre of the device. Besides or in addition to the aforementioned geometric contrast, a brightness contrast can also be used, for example the passage surface may have a light surface and the opening in the centre may have a dark or black surface. It would also be possible for the passage surface conversely to be dark and for the opening within the passage opening to be light.

Furthermore, however, it would also be possible to fit the passage surface on a circumferential wall of the housing, since in this case too the air flow could be directed upwards.

In the embodiment according to the invention, the housing is, as mentioned above, watertight and the aforementioned air plume is emitted 100% upwards, so that the gnats can be drawn directly into the suction duct there.

In a further advantageous embodiment, a circulating water flow is additionally used in the interior of the housing. By virtue of this circulating water flow, it is possible also to attract the female mosquitoes who are not seeking the blood of the host but rather a place for laying eggs. In this way, the breeding of the insects around the device is also avoided. The circulation of the water flow can be achieved both by the ventilation device and also by additional pumps for example. More specifically, due to the air flow impinging on the liquid, liquid molecules are also entrained upwards, that is to say in the direction of the passage surface, and can exit through the passage surface.

In a further advantageous embodiment, the attracting plane has a metallic surface. With particular preference, the attracting plane is made from aluminium and in particular from a brushed aluminium material.

In a further advantageous embodiment, the duct protrudes outwards relative to the attracting plane. In this way, the insects can be sucked through the duct into the interior before touching the attracting plane. In one particularly preferred embodiment, the attracting plane together with the duct and optionally a control device is formed in one piece as a lid. This lid is placed or screwed onto the housing. The ventilation device is preferably arranged at the lower end of the duct and above the liquid. In one advantageous embodiment, a warning device such as a filling level indicator is provided so as to prevent the ventilation device from becoming wet. However, it would also be possible to provide an opening in the housing below the ventilation device, via which opening excess liquid can flow off. It would also be possible to configure this opening as a filling opening for filling the housing.

In a further advantageous embodiment, the liquid is water. With particular preference, the water is enriched with a surfactant. Surfactants are substances which have an effect on the surface tension at the interface between two phases. By using a water with added surfactant, the surface tension of the water can be reduced and thus the insects making contact with the water surface can be efficiently drawn below the water surface.

In a further advantageous embodiment, at least one heating device is provided in the interior of the housing. By virtue of this heating device, an increase in heat output can be achieved and thus likewise the attractive force for the insects can be increased. Research has shown that, besides possible scents and optical stimuli, the thermal image also plays a significant role. In this case it is possible both to provide the heating device in the region of the liquid, so that the liquid is heated directly, or also to provide the heating device above the liquid, so that the rising liquid molecules are heated as they pass through the heating device. By means of a control device, the power of this heating device can advantageously be controlled and thus can be adapted for example to different outside temperatures. A particularly efficient attracting effect for insects can thus always be achieved, regardless of the respective outside temperature.

In a further advantageous embodiment, an illumination device which illuminates the attracting plane is provided in the interior of the housing. This may be for example an illumination device which emits ultraviolet light and thus illuminates the attracting plane. It is also possible to increase already existing light/dark contrasts by an enhancement or an illumination from below. In this way, the attracting force of the device according to the invention can be further amplified. The illumination device can thus preferably also emit light in the visible wavelength range.

In a further advantageous embodiment, at least one holding device for an attractant for attracting insects is provided in the interior of the housing. In one advantageous embodiment, this holding device is located in the interior of the duct and thus above the ventilation device. However, it would also be possible to provide a holding device for example directly below the ventilation device or even between the duct and the housing wall, so that the medium rising from the liquid surface passes through the attractant.

In a further advantageous embodiment, acoustic signal emitters, such as loudspeakers, may also be arranged in the interior of the housing, which also exert acoustic stimuli on the insects to be attracted.

In a further preferred embodiment, the attracting plane has on its outer surface at least two surface portions with different brightnesses.

Further advantages and embodiments will emerge from the appended drawings:

In the drawings:

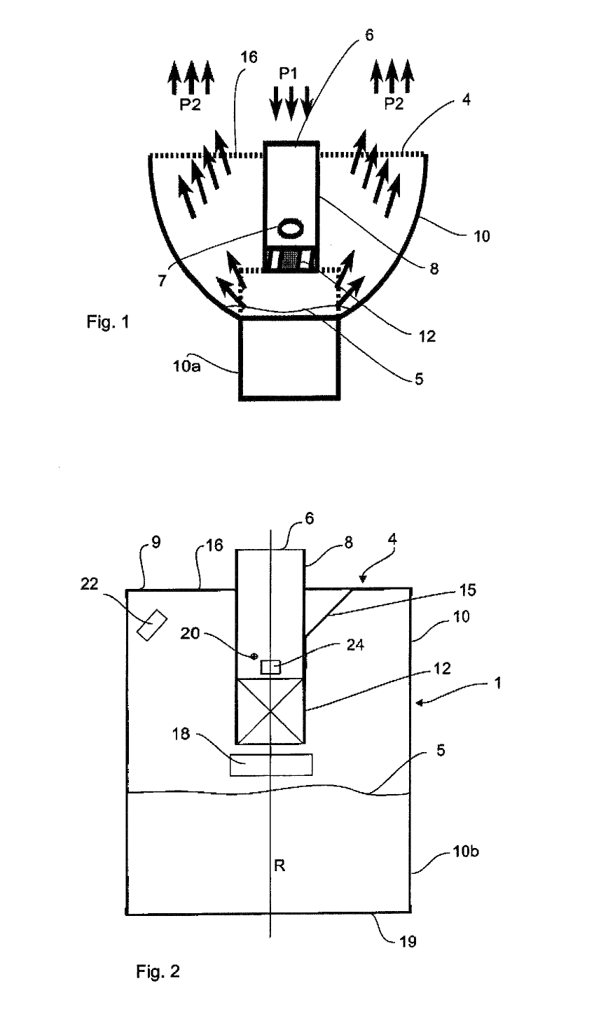

FIG. 1 shows a schematic diagram to illustrate the principle on which the invention is based;

FIG. 2 shows a schematic diagram of a device according to the invention;

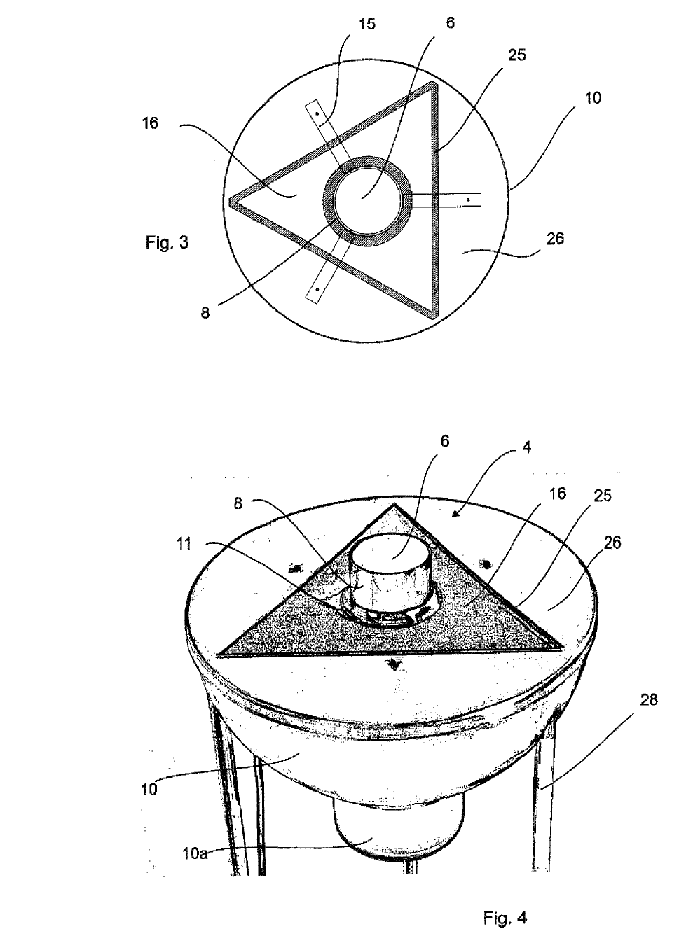

FIG. 3 shows a plan view of a device according to the invention; and

FIG. 4 shows a perspective view of a device according to the invention.

FIG. 1 shows a schematic diagram of a device 1 according to the invention. This device comprises a surface or attracting plane 4. This attracting plane is in turn composed of a passage surface 16, through which a gaseous medium can pass, an opening 6 arranged within this passage surface, and a region surrounding this passage surface. Furthermore, this passage surface 16 is surrounded by a frame which may exhibit a colour contrast compared to this passage surface. The opening 6 opens into a duct 8 which protrudes into the interior of a housing 10. This housing 10 is closed in the downward direction and to the side, so that it can hold a liquid 5, such as water for example.

Provided at the lower end of the duct is a ventilation device 12 which causes an air flow from top to bottom through the duct 8 in the direction of the arrows P1. Furthermore, the air flow generated by the ventilation device also reaches the water surface, is reflected from there and moves upwards to the side of the duct and through the passage surface 16 towards the outside, as illustrated by the arrows P2. In this way, liquid molecules are also entrained upwards. Liquid may likewise be arranged in a housing part 10a. It would also be possible to provide for example illumination devices on this housing part. Reference 7 denotes a dispenser in which there is arranged an attractant which mingles with the air flowing past.

FIG. 2 shows a diagram of a device according to the invention in cross-section. It can be seen that both the opening 6 and the duct 8 together with the passage surface 16 are arranged in a lid 9. This lid is placed onto the housing 10 and for example is screwed onto the latter. It is therefore possible to remove the lid 9 in its entirety, that is to say together with the duct 8, and then for example to clean it or to empty the container in order to remove insects that have been caught. Reference 15 denotes support devices which arrange the duct 8 securely on the lid 9. These support devices can be screwed to the lid 9. The embodiment shown in FIG. 2 is thus symmetrical relative to a rotation axis R.

Operation of the ventilation device 12 can take place directly via a socket or via a battery. Due to the low power consumption of the ventilation device, the device can continue to operate overnight and in the absence of the user in order to guarantee an optimum yield. In one preferred embodiment, it is possible to integrate an optional CO2 module in the interior of the housing, for example also in the interior of the duct 8 or else between the duct and the housing inner wall, which CO2 module increases the effectiveness of the device. By adding CO2 tablets, which dissolve in the liquid medium, carbon dioxide can likewise be generated. Preferably, however, such an add-on module is not used in closed spaces.

The insects 20 sucked through the duct 8 reach the surface of the liquid 5 and, since the surface tension of the latter has been suppressed as mentioned above, the insects sink. The caught and killed insects are thus hygienically collected in the collecting container 10a (FIG. 1) and can be disposed of easily. Replacement of an optional attractant is then necessary only approximately every 6 months.

Reference 18 denotes a heating device which heats the air passing through the duct 8 onto the water surface 5. However, the heating device could also be arranged at a different location, for example circumferentially around the duct 8 or else inside the liquid 5. The housing 10 and the duct 8 are concentric relative to a rotation axis R.

FIG. 3 shows a plan view of a device according to the invention for catching insects. In this embodiment, the passage surface 16 is surrounded by a triangular edge 25 and the duct 8 has a circular cross-section. In this way, a geometric contrast which attracts the insects is produced on the attracting plane 4 as a whole. In one embodiment, it is possible to design the passage surface in a light colour, for example in white or in a metallic gloss, and to make the opening 6 dark, which can be achieved for example by a black lacquering of the inner wall of the duct 8. In further advantageous embodiments, both the passage surface 16 and the opening 6 are kept dark and only the lid section 26 which surrounds the triangular edge 25 is kept in a light colour. In this embodiment, the insects to be caught are likewise effectively attracted. It would also be possible to make both the opening 6 and the passage surface 16 light.

Conversely, it would also be possible that the duct 8 has a polygonal, for example square, cross-section and is surrounded by a circular edge. Instead of a circular cross-section, use could also be made of approximately circular cross-sections, such as elliptical cross-sections or polygonal cross-sections with a large number of corners. Finally, triangles and squares or rectangles arranged within these triangles could also be provided as the geometric contrasts.

FIG. 4 shows a perspective view of a device according to the invention for catching insects. It can be seen here that both the duct 8 and the passage surface 16 and the lid section 26 surrounding this passage surface are arranged in a lid 9, which is in turn attached to the housing 10. The ventilation device 12 used is in particular a duct fan. The duct 8 is particularly preferably a PVC duct, the internal diameter of which lies in a range between 70 mm and 150 mm, preferably between 80 mm and 130 mm, and particularly preferably between 90 mm and 110 mm. The passage surface 16 is particularly preferably formed from a fine-mesh netting. On the underside, the housing 10 can be glued around the circumference to a bottom 19 (cf. FIG. 2), or else welded thereto. The circular opening 8 and the triangular edge 25 are concentric with one another.

The passage surface 16 is particularly preferably glued to the edge 25. Reference 11 denotes a bead which joins the duct 8 to the passage surface 16.

The present invention can be used for example by private individuals, for example in households. In addition, however, these devices can also be used in hotels, in restaurants or in industrial kitchens. The device is also suitable for use in hospitals, sanatoria, public buildings, train stations or airports and also on ships and in the motor vehicle or caravan sector. In further embodiments, it is possible to integrate directly the device according to the invention, for example in a building or in the walls thereof. More precisely, the device according to the invention can be integrated without any problem into the architecture and interior room design of the relevant area of use.

The housing is particularly preferably made from a metal, wherein, depending on the use, besides aluminium, the metal used could also be stainless steel, titanium, copper and other such materials. The device according to the invention can be placed on the floor via feet 28, but rollers could also be fitted for example at the lower end of these feet in order to be able to move the device.

However, particularly for use in lower price categories, it would also be possible to make essential parts of the device from a plastic, such as the duct and the housing. Furthermore, it would also be possible for the entire device to be made from a plastic.

The present device can also be used as a humidifier, in particular in addition to its use as an insect trap. In this embodiment, the heating device arranged in the interior of the housing is preferably used to heat the liquid. In addition, special filter devices may be used which filter the water vapour exiting from the device. The applicant reserves the right to claim the use of the device both as an insect trap and as a room humidifier.

In addition, it is also possible to use the device for fragrancing rooms and for uses in the aromatherapy sector. This use, too, is conceivable instead of or in addition to the use as an insect trap. In this case, preferably the liquid is enriched with an aromatic substance, but it would also be possible to enrich the vapour generated in the device with aromatic substances.

The device according to the invention can on the one hand be used in a freestanding manner, but it would also be possible to integrate the device directly for example in buildings, e.g. by incorporating it in walls, floors or ceilings. In these installations, the house's own ventilation or water supply systems and also the mains power could also be used.

It would also be possible to use the device according to the invention in vehicles for travelling on land, in the air and in water, for example on luxury yachts or in aeroplanes.

In such embodiments, it would be conceivable to provide supply and discharge lines for the liquid on the housing of the device, so that liquid containing dead insects can be removed by suction and fresh liquid can be supplied.

All of the features disclosed in the application documents are claimed as essential to the invention in so far as they are novel individually or in combination with respect to the prior art.

### LIST OF REFERENCES

1 device for catching insects
4 attracting plane
5 liquid
6 opening
7 dispenser
8 duct
9 lid
10 housing
10a collecting container
12 ventilation device
15 support device
16 passage surface
18 heating device
19 bottom
20 insects
25 edge
26 lid section
28 foot
P1, P2 arrows
R rotation axis

1. A device for catching insects, comprising an attracting plane for attracting the insects to be caught, comprising an opening which is arranged in the attracting plane (4) and through which the insects can enter the insect trap, wherein the opening is adjoined by a duct which extends into the interior of the insect trap, and comprising a ventilation device which generates an air flow passing through the duct, wherein the duct is arranged in the interior of a housing and this housing is provided for receiving and holding a liquid medium, wherein the ventilation device is arranged in such a way that it generates an air flow in the direction of the liquid medium provided in the housing.

2. The device according to claim 1, wherein the opening is provided within a passage surface through which a gaseous medium can exit from the device.

3. The device according to claim 1, wherein at least two different geometric designs are formed on the attracting plane.

4. The device according to claim 1, wherein the attracting plane has a metallic surface.

5. The device according to claim 1, wherein the duct protrudes inwards and outwards relative to the attracting plane.

6. The device according to claim 1, wherein the liquid is water.

7. The device according to claim 1, wherein at least one heating device is provided in the interior of the housing.

8. The device according to claim 1, wherein at least one illumination device which illuminates the attracting plane is provided in the interior of the housing.

9. The device according to claim 1, wherein at least one holding device for an attractant for attracting insects is provided in the interior of the housing.

10. The device according to claim 1 wherein the attracting plane has on its outer surface at least two surface portions with different brightnesses.
